(19) United States
(12) Patent Application Publication
(10) Pub. No.: US 2009/0036646 A1
(43) Pub. Date: Feb. 5, 2009

(54) DRYING PROCESS FOR POLYMER CROSSLINKED BI-CONTINUOUS MACRO-MESOPOROUS AEROGELS

(76) Inventors: Hongbing Lu, Edmond, OK (US); Nicholas Leventis, Rolla, MO (US)

Correspondence Address: FELLERS SNIDER BLANKENSHIP;BAILEY & TIPPENS, THE KENNEDY BUILDING, 321 SOUTH BOSTON SUITE 800, TULSA, OK, 74103-3318, US

(21) Appl. No.: 12/185,372

(22) Filed: Aug. 4, 2008

Related U.S. Application Data
(60) Provisional application No. 60/953,769, filed on Aug. 3, 2007.

(51) Int. Cl. C08F 6/10

(52) U.S. Cl. 528/492; 528/495; 528/498

(57) ABSTRACT

A method of drying an aerogel is disclosed. The method includes washing the aerogel in acetone, washing the aerogel in pentane, and heating the aerogel in the presence of pentane. The aerogel is removed from the pentane and the heating continues.

### CROSS REFERENCE TO RELATED APPLICATIONS

This application claims the priority of U.S. Provisional Patent Application No. 60/953,769 entitled “DRYING PROCESS FOR POLYMER CROSSLINKED BI-CONTINUOUS MACRO-MESOPOROUS AEROGELS,” filed Aug. 3, 2007, the contents of which are hereby incorporated by reference.

### STATEMENT REGARDING FEDERALLY SPONSORED RESEARCH OR DEVELOPMENT

This invention was made with government support under grant number CMS-0555902 awarded by the National Science Foundation. The government has certain rights in the invention.

### FIELD OF THE INVENTION

This disclosure relates to aerogels in general and, more specifically, to methods and apparatus for the preparation of aerogels.

### BACKGROUND OF THE INVENTION

Aerogels are low density nano-porous materials with low thermal conductivity as well as high acoustic attenuation value. These are just a few of the properties that make this class of materials attractive to engineers and scientists. In addition, aerogels previously required supercritical drying in order to get the desired monoliths without excess shrinkage and cracking which would otherwise occur if they were dried in ambient air.

In so called supercritical drying methods, a crosslinked aerogel is immersed in CO₂ in a pressurized autoclave. The temperature in the autoclave is increased to near room temperate. The pressure is suddenly removed such that the evaporated CO₂ will take the moisture in the crosslinked aerogels. It can be appreciated that this method requires autoclaves equipped with pressure vessels to conduct the supercritical fluid extraction techniques. Such equipment may not always be readily available and serviceable.

What is needed is a method and apparatus to address the above, and related, issues.

### SUMMARY OF THE INVENTION

The present invention disclosed and claimed herein, in one aspect thereof comprises a method of drying an aerogel. The method includes washing the aerogel in acetone, washing the aerogel in pentane, and heating the aerogel in the presence of pentane. The aerogel is removed from the pentane and the heating continues, possibly for a time sufficient to dry the aerogel.

In some embodiments, the aerogel is washed in acetone at 8 hour intervals. Washing in pentane may further comprise washing in pentane at least 4 times at intervals of about 8 hours.

In some embodiments the aerogel is heated in the presence of fresh pentane at about 40° C. for about 2 hours. The aerogel may be removed from the pentane for continued heating at about 40° C. for about 4 hours.

### DETAILED DESCRIPTION OF THE PREFERRED EMBODIMENTS

Cross-linked sol-gel type materials and cross-linked aerogels, along with methods for making the same, have been described in various publications such as U.S. Patent Application Serial No. US2004/0132846 by Levintis et al. (hereby incorporated by reference). The aerogel materials described in the Levintis publication rely on an autoclave device for manufacture, and result in a random nanostructure. The pore size will be on the order of 50 nm and the material will sink when immersed in water. Furthermore, when the materials are dried, they will shrink significantly.

The present disclosure provides for an ambient drying process for cross-linked templated silica aerogels. The cross-linked templated silica aerogels of the present disclosure comprise templated silica nanoparticles nanoencapsulated by polymers. The pore size is on the order of a few microns (e.g., 5 microns). The microstructures are highly ordered. The highly ordered nature of the silica nanoparticles (e.g., polymer-polyurea) gives the present aerogels very high stability. For example, the material does not absorb much water. The material absorbs only a small percentage of moisture (˜5%) even when immersed in water for extended periods of time. The material will float on water for periods of months. Additionally, the dimensions remain substantially unchanged when the material is dried to remove any accumulated moisture.

In one embodiment, the present disclosure provides a method that allows wet aerogel monoliths to be dried in ambient air using pentane as a solvent exchange fluid. An exemplary procedure may be used to prepare at least one class of aerogels, namely the cross-linked templated silica aerogels (CTSA). These are cross-linked with siocyanate-derived polymer and dried using pentane as a solvent exchange fluid, instead of the CO₂ that is typically used in supercritical drying process.

Sample preparation was performed as follows

Templated aerogels were prepared using the following:

1. 1.0 M HNO₃ (from Fisher chemicals/Fisher scientific, Pittsburgh, Pa. 15275).

2. Triblock copolymer (pluronic P123) (from Sigma-Aldrich Inc., St. Louis, Mo. 63103).

3. Mesitylene 99%, (TMB) (from Across organic, New Jersey).

4. Tetramethyl orthosilicate C₄H₁₂O₄Si (TMOS) (from Sigma-Aldrich, Inc., St. Louis, Mo. 63103).

5. 10 ml syringes (from BD syringes, Franklin Lakes, N.J. 07417).

6. HPLC grade Acetone (from Pharmco-AARER and commercial alcohols, Shelbyville, Ky. 40065).

7. HPLC grade alcohol (from Pharmco-AARER and commercial alcohols, Shelbyville, Ky. 40065).

8. HPLC grade acetonitrile (CH₃CN) (from Pharmco-AARER and commercial alcohols, Shelbyville, Ky. 40065).

9. Hexamethylene-1,6 diisocyanate (Desmodur N3200) (from Bayer material science, Pittsburgh, Pa. 15205).

10. Parafilm (from American Can Company, Dixie/Marathon, Greenwich, Conn. 06830)

11. PTFE thread seal tape.

12. Oven.

An exemplary procedure for preparing templated silica aerogels was performed as follows: 4.0 grams of P123 was dissolved in 120. grams of 1.1 M HNO₃. The mixture was stirred using a magnetic stirring bar until all chunks of pluronic P123 have been dissolved and are no longer visible. Depending on the type of templated silica aerogels are desired, an amount of TMB is added and the mixture is continuously stirred. The various ratios of TMB used for our case are as shown in table 1. The mixture was then cooled to 0° C., still under vigorous stirring for 30 minutes. Once the solution has cooled to 0° C., 5.15 grams of TMOS was added and after stirring for about 10 minutes, the solution was poured into prepared syringe molds. Two layers of para-film followed by two layers of PTFE thread seal tape and then two more layers of para-film were used to cover the open end of the mold. The samples were set standing vertically so that any air that may have been trapped in the mixture could rise to the top. Finally, the samples were placed in the oven set at 60° C. for gelation that is followed by aging. The samples were monitored every 10 to 15 minutes to determine when gelation had occurred and then the samples were left in the 60° C. oven to age for a period that is five times the gelation time. Gelation time depends on the amount of TMB added.

TABLE 1
Various ratios of the chemicals used in the
preparation of templated silica aerogels.

| | 1.0M | Pluronic | | | | N3200/ |
|---|---|---|---|---|---|---|
| Sample | HNO₃ | P123 | TMB | TMOS | CH₃OH | Acetone |
| ID | (gm) | (gm) | (gm) | (gm) | (gm) | (gm/ml) |
| X-MPO | 12 | 0 | 0 | 5.15 | 7.1 | 11/94 |
| X-MP4- | 12 | 4 | 0 | 5.15 | 0 | 11/94 |
| X-MP4- | 12 | 4 | 0.45 | 5.15 | 0 | 11/94 |
| T045 | | | | | | |
| X-MP4- | 12 | 4 | 0.65 | 5.15 | 0 | 11/94 |
| T065 | | | | | | |
| X-MP4- | 12 | 4 | 0.85 | 5.15 | 0 | 11/94 |
| T085 | | | | | | |
| X-MP4- | 12 | 4 | 0.9 | 5.15 | 0 | 11/94 |
| T090 | | | | | | |
| X-MP4- | 12 | 4 | 1.25 | 5.15 | 0 | 11/94 |
| T125 | | | | | | |
| X-MP4- | 12 | 4 | 2 | 5.15 | 0 | 11/94 |
| T200 | | | | | | |
| X-MP4- | 12 | 4 | 3.1 | 5.15 | 0 | 11/94 |
| T310 | | | | | | |

After aging, the samples were washed two times in alcohol at 8 hour intervals. The samples were then placed in soxholet extractor where P123 was removed using acetonitrile as the solvent fluid. The samples stayed in the soxholet for two days and then they were washed four times in acetone at 8 hour intervals. The amount of alcohol and acetone used during washings was approximately 4-5 times the volume of the gel. The samples were then placed in a solution containing 11 grams on N3200 and 94 ml of acetone for cross-linking. The volume of cross-linking solution should be 4-5 times the volume of the gel. Samples were left in the solution for about 36 hours and were constantly stirred to help reach equilibrium. The samples were then transferred to the oven set at 55° C. for 3 days. Thereafter, the samples were washed four times in acetone to remove any excess N3200. At this point, the samples were ready for pentane drying. In the present embodiment, we performed the following steps:

1. After cross-linking in N3200, wash 4 times in HPLC grade acetone at 8 hour intervals to remove an excess N3200.

2. Wash the samples in HPLC grade pentane 4 times at 8 hours interval.

3. Replace pentane after the fourth wash with fresh pentane and place the samples with pentane in an oven at 40° C. for at least two hours.

4. Together with the samples keep also a Petri dish in the oven at 40° C.

5. Remove the samples from the pentane and quickly place them on the warm Petri dish in the oven and let them dry for about 4 hours at 40° C.

Embodiments of the present methods disclosed herein resulted in the following: (1) extraction of P123 without calcinations at 600° C.; and (2) obtaining monolithic aerogels without SCF drying, and without shrinking or cracking. With these steps, these methods can be used to make both small and large samples. For making large samples, we have eliminated the size limitation since as a large oven is not needed to heat the aerogels to 600° C. for calcinations. The present methods also do not require an autoclave (typically 1050 psi-1150 psi, cooled between 0 and 10° C. using liquid CO₂) for supercritical drying, which also limited the size samples could previously reach.

Thus, the present invention is well adapted to carry out the objectives and attain the ends and advantages mentioned above as well as those inherent therein. While presently preferred embodiments have been described for purposes of this disclosure, numerous changes and modifications will be apparent to those of ordinary skill in the art. Such changes and modifications are encompassed within the spirit of this invention as defined by the claims.

What is claimed is:

1. A method of drying an aerogel comprising:
washing the aerogel in alcohol.
washing the aerogel in acetone;
washing the aerogel in pentane;
heating the aerogel in the presence of pentane; and
removing the aerogel from the pentane and continuing the heating.

2. The method of claim 1, wherein washing in acetone comprises washing in acetone at 8 hour intervals.

3. The method of claim 1 wherein washing in pentane comprises washing in pentane at least 4 times at intervals of about 8 hours.

4. The method of claim 1 wherein heating in the presence of pentane comprises heating to about 40° C. for about 2 hours.

5. The method of claim 4, wherein fresh pentane is used for heating in the presence of pentane.

6. The method of claim 1, wherein removing the aerogel from the pentane and continuing the heating further comprises heating at about 40° C. for about 4 hours.

7. The method of claim 1, wherein washing the aerogel in acetone comprises washing the aerogel in a cross-linking solution comprising acetone and hexamethylene-1,6 diisocyanate.

8. A method of drying a cross-linked aerogel comprising:
washing the aerogel in pentane;
heating the aerogel in the presence of pentane; and
removing the aerogel from the pentane and continuing the heating.
